(19) United States
(12) Patent Application Publication
(10) Pub. No.: US 2010/0002099 A1
(43) Pub. Date: Jan. 7, 2010

(54) METHOD AND APPARATUS FOR SHARING MEMORY

(75) Inventors: Kyung-Chul Min, Seoul (KR); Yong-Hwan Kim, Goyang-si (KR)

Correspondence Address: BIRCH STEWART KOLASCH & BIRCH, PO BOX 747, FALLS CHURCH, VA, 22040-0747, US

(73) Assignee: MTEKVISION CO., LTD., Seoul (KR)

(21) Appl. No.: 12/375,357

(22) PCT Filed: Jul. 27, 2007
(86) PCT No.: PCT/KR07/03640

§ 371 Date: Jan. 27, 2009

(30) Foreign Application Priority Data
Jul. 28, 2006 (KR) 10-2006-0071745

(51) Int. Cl. H04N 5/76

(52) U.S. Cl. 348/231.99

(57) ABSTRACT

A digital processing apparatus using a memory sharing structure through a bypass logic and a sharing method thereof are disclosed. According to an embodiment of the present invention, the digital processing apparatus includes an application processor, a supplementary memory unit, which is subordinate to the application processor, and a main processor, which controls the application processor. If no communication is made using a control bus between the main processor and the application processor, the application processor connects a route to allow the main processor and the supplementary memory unit to be directly coupled to each other by executing a predetermined bypass logic. Through this, the capacity of a useable memory of the main processor can be maximized.

### CROSS-REFERENCE TO RELATED APPLICATIONS

This application claims foreign priority benefits under 35 U.S.C. sctn. 119(a)-(d) to PCT/KR2007/003640, filed Jul. 27, 2007, which is hereby incorporated by reference in its entirety.

### BACKGROUND

1. Technical Field

The present invention relates to the sharing of a storing apparatus, more specifically to a digital processing apparatus using a sharing structure of a memory through a bypass logic and a sharing method thereof.

2. Description of the Related Art

A portable terminal refers to a compact electronic device that is designed to be easily carried by a user in order to perform functions such as game or mobile communication. The portable terminal can be a mobile communication terminal, a personal digital assistant (PDA), or a portable multimedia player (PMP).

The mobile communication terminal is essentially a device designed to enable a mobile user to telecommunicate with a receiver who is remotely located. Thanks to scientific development, however, the latest mobile communication terminals have functions, such as camera and multimedia data playback, in addition to the basic functions, such as voice communication, short message service and address book

FIG. is a block diagram illustrating a mobile communication terminal having a conventional camera function.

Referring to FIG. 1, the mobile communication terminal 100 having a camera function includes a high frequency processing unit 110, an analog-to-digital converter 115, a digital-to-analog converter 120, a processing unit 125, a power supply 130, a key input 135, a main memory 140, a display 145, a camera 150, an video processing unit 155 and a support memory 160.

The high frequency processing unit 110 processes a high frequency signal, which is transmitted or received through an antenna.

The analog-to-digital converter 115 converts an analog signal, outputted from the high frequency processing unit 110, to a digital signal and sends it to the processing unit 125.

The digital-to-analog converter 120 converts a digital signal, outputted from the processing unit 125, to an analog signal and sends it to the high frequency processing unit 110.

The processing unit 125 controls the general operation of the mobile communication terminal 100. The processing unit 125 can include a central processing unit (CPU) or a micro-controller.

The power supply 130 supplies electric power required for operating the mobile communication terminal 100. The power supply 130 can be coupled to, for example, an external power source or a battery.

The key input 135 generates key data for, for example, setting various functions or dialing of the mobile communication terminal 100 and sends the key data to the processing unit 125.

The main memory 140 stores an operating system and a variety of data of the mobile communication terminal 100. The main memory 140 can be, for example, a flash memory or an EEPROM (Electrically Erasable Programmable Read Only Memory).

The display 145 displays the operation status of the mobile communication terminal 100 and an external video photographed by the camera 150.

The camera 150 photographs an external image (a photographic subject), and the image processing unit 155 processes the external image photographed by the camera 150. The image processing unit 155 can perform functions such as color interpolation, gamma correction, image quality correction and JPEG encoding. The support memory 160 stores the external image processed by the image processing unit 155. The support memory 160 can be an SRAM (Static RAM) or an SDRAM (Synchronous DRAM).

As described above, the mobile communication terminal 100 having a camera function is equipped with a plurality of processing units (that is, a main processor and one or more application processors for performing additional functions). In other words, as shown in FIG. 1, the processing unit 125 for controlling general functions of the mobile communication terminal 100 and the image processing unit 155 for controlling the camera function are included. Each processing unit is structured to be coupled with an independent memory.

The application processor can take different forms and quantity depending on the kinds of additional functions, with which the portable terminal is equipped. For example, the application processor for controlling the camera function can process functions such as JPEG encoding and JPEG decoding; the application processor for controlling the movie file playback function can process functions such as video file encoding and decoding; and the application processor for controlling the music file playback function can process functions such as audio file encoding and decoding. There is separately provided a memory for storing data processed by a pertinent application processor in each of the application processors.

In this structure, various attempts to allow a memory occupied by each application processor to be shared with another application processor or the main processor have been developed in order to expand a storage space or improve the processing efficiency. This case features a processor (i.e. the main processor or an application processor) which can use a certain memory by using a bus controller or a selector.

FIG. 2 through FIG. 3 illustrate the sharing structure of a conventional memory.

Referring to FIG. 2, the main processor 210 is connected to the application processor 220 through a control bus 250. A shared memory 230 is connected to a first memory and a second memory through a first memory bus 240a and a second memory bus 240b, respectively. The main processor 210 can have a main memory (not shown) subordinate to the main processor 210.

Referring to FIG. 3, there are the shared memory 230 and the application processor 220 in a system 300 in a form of one chip. The application system 300 and the main processor 210 are connected to each other through the memory bus 240 and the control bus 250. Similarly, the main processor 210 can have a main memory (not shown) subordinate to the main processor 210.

The application processor 220 is required to be controlled by the main processor 210 through the buses. In other words, the main processor 210 is required to have not only a bus controller but also a control logic for controlling the application processor 220.

In order to allow the main processor 210 to share the shared memory 230 with the application processor 220, time allotment is used to make it possible to successively access and use the shared memory 230 by using a control logic. For example, the main processor 210 is allowed to access and use the shared memory 230 during a first period of time, and the application processor 220 is allowed to access and use the shared memory 230 during a second period of time, which is not the first period of time. Alternatively, the priority order of accessing the shared memory 230 is determined to allow the main processor 210 or the application processor 220 to access and use the shared memory 230 through the control logic according to the priority order.

For this, the main processor 210 and the application processor 220 are required to know the accessible time or the access priority order to the main processor. The control logic of the main processor 210 performs this operation through the communication between each processor by using the control bus.

It is possible that the communication is performed between each processor by using the control bus and thus the shared memory 230 is used through the memory bus connected to the shared memory 230 according to the allotted time or the priority order.

However, this case needs a lot of communication lines such as the control bus and the memory bus. Also, the number of package pins is increased in case that the application processor 220 and the shared memory 230 are provided as one chip.

### SUMMARY

Accordingly, the present invention provides a digital processing apparatus having a memory sharing structure capable of reducing communication lines by allowing a main processor and an application processor to share a memory with each other though a control bus, and a sharing method thereof.

The present invention also provides a digital processing apparatus having a memory sharing structure capable of reducing the number of package pins by providing an application processor and a memory as one chip and using no memory pin outside of a corresponding chip package, and a sharing method thereof.

To solve the above problems, an aspect of the present invention features a digital processing apparatus having a memory sharing structure, the apparatus including an application processor, performing a predetermined application function, the function including at least one of a camera function and a multimedia playing back function; a supplementary memory unit, coupled to or inserted into the application processor such that the supplementary memory is subordinate to the application processor; and a main processor, coupled to the application processor through a control bus and controlling the start or stop of driving the application processor through the control bus, whereas if communication through the control bus is not performed, a route is connected to directly couple the main processor to the supplementary memory unit through the control bus.

Preferably, the supplementary memory unit can have two or more ports, and a storing area of the supplementary memory unit can be partitioned into n sections, n being a natural number. Here, it is possible that the application processor and the main processor simultaneously share the supplementary memory unit at any time.

The application processor can have a bypass logic to connect the route, the bypass logic being executed in case no communication is made between the main processor and the application processor, the application processor transmitting corresponding state information to the main processor after executing the bypass logic.

Alternatively, the application processor can have a bypass logic to connect the route, the bypass logic being executed by a command from the main processor which has detected that no communication is made between the main processor and the application processor.

Also, the main processor can write or read data, which is processed or to be processed, in or from the supplementary memory unit supplementary memory through the control bus and the route.

Another aspect of the present invention features a method sharing a memory to allow a main processor to use a supplementary memory unit in a digital processing apparatus, the digital processing apparatus including the main processor, an application processor performing a predetermined application function, and the supplementary memory unit subordinately coupled the application processor, the method including: (a) determining whether communication using a control bus is made between the main processor and the application processor; (b) if no communication is made, connecting a route to allow the main processor and the supplementary memory unit to be directly coupled to each other by having the application processor execute a bypass logic; and (c) having the main processor process the data processed or to be processed in the supplementary memory unit, coupled through the control bus and the route.

Preferably, the supplementary memory unit can have two or more ports, and a storing area of the supplementary memory unit can be partitioned into n sections, n being a natural number. Also, it is possible that the application processor and the main processor simultaneously share the supplementary memory unit at any time.

Alternatively, between the step (b) and the step (c), the application processor can transmit corresponding state information to the main processor after connecting the route.

Also, in the step (b), the bypass logic can be executed by a command from the main processor which has detected that the application processor performs the application function.

In the step (c), the main processor can write or read data, which is processed or to be processed, in or from the supplementary memory unit supplementary memory unit through the control bus and the route.

Other problems, certain benefits and new features of the present invention will become more apparent through the following description with reference to the accompanying drawings and some embodiments.

### BRIEF DESCRIPTION OF THE DRAWINGS

FIG. is a block diagram illustrating a mobile communication terminal having a conventional camera function;

FIG. 2 through FIG. 3 illustrate the sharing structure of a conventional memory;

FIG. 4 illustrates the sharing structure of a memory in accordance with an embodiment of the present invention;

FIG. 5 illustrates the structure of an supplementary memory unit in accordance with the present invention;

FIG. 6 is a flow chart illustrating a process of storing processing data of a main processor in an supplementary memory unit subordinate to an application processor in accordance with an embodiment of the present invention; and

FIG. 7 is a flow chart illustrating a process of storing processing data of a main processor in an supplementary memory unit subordinate to an application processor in accordance with another embodiment of the present invention.

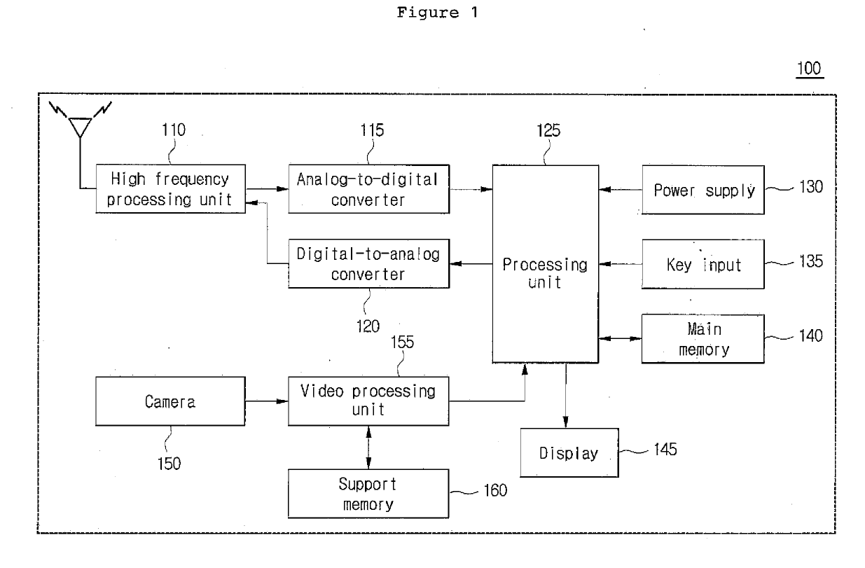

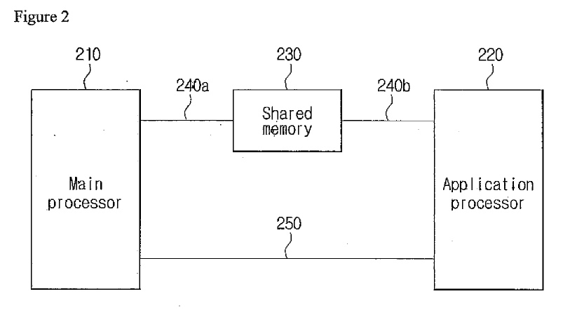

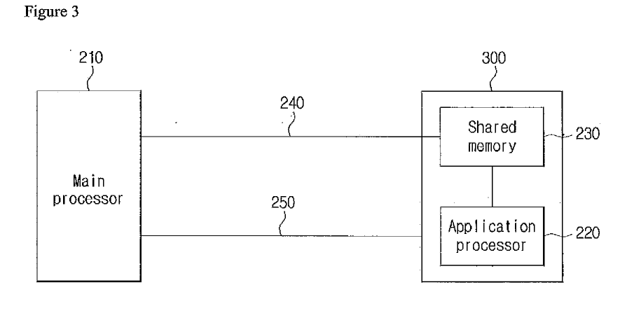

### DETAILED DESCRIPTION

Hereinafter, some embodiments of a digital processing apparatus having a memory sharing structure and a sharing method thereof in accordance with the present invention will be described in detail with reference to the accompanying drawings. Throughout the description of the present invention, when describing a certain technology is determined to evade the point of the present invention, the pertinent detailed description will be omitted. Terms (e.g. “first” and “second”) used in this description merely are identification for successively identifying identical or similar elements.

Also, it is natural that the sharing method in accordance to the present invention can be applied to all digital processing apparatuses or systems (e.g. mobile communication terminals, PDAs and portable multimedia players), portable apparatus such as MP3 players, digital cameras, digital televisions and sound devices and/or home digital equipments equipped in home. However, the below description is based on the portable apparatus for the convenience of description and understanding.

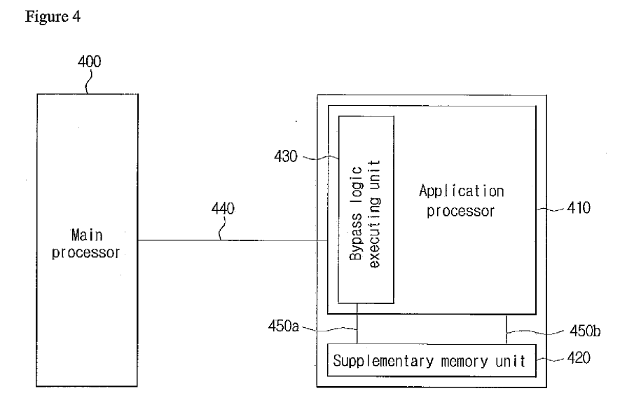

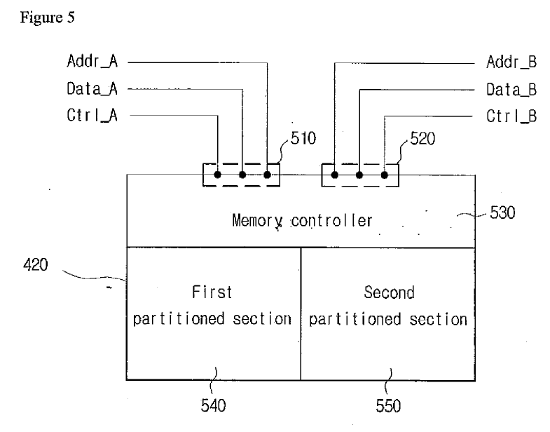

FIG. 4 illustrates the sharing structure of a memory in accordance with an embodiment of the present invention, and FIG. 5 illustrates the structure of an supplementary memory unit in accordance with the present invention

As illustrated in FIG. 4, the portable apparatus for performing a memory sharing method in accordance with the present invention includes a main processor 400, an application processor 410 and an supplementary memory unit 420. It is assumed that the application processor 410 is connected to the main processor 400 through a control bus only and is not connected to the main processor 400 through a memory bus (not shown). The supplementary memory unit 420 is coupled to or inserted into the application processor 410 to be subordinate to the application processor 410.

Here, the main processor 400 can be a processor which is able to control a typical operation of the portable apparatus and to send a command (e.g. an operation start command and an operation stop command) to each element. The main processor 400 can be coupled to or include a separate main memory, which is not shown in FIG. 4.

The application processor 410 can be a dedicated processor for processing MPEG4, 3D graphic and a camera function. Although the description related to FIG. 4 assumes the case of 1 application processor, it is obvious that the number of the application processors can be increased according to types of functions of the portable apparatus.

It can be easily understood that the portable apparatus, applicable to the present invention, is not limited to a certain type of apparatus and is able to be identically applied to any apparatus which is configured to include the application processor 410 and the supplementary memory unit 420.

The application processor 410 includes a bypass logic executing unit 430 for controlling whether the application processor 410 is interfaced with the dependant supplementary memory unit 420. The bypass logic executing unit 430 executes a bypass logic such that the main processor 400 can subjectively use the supplementary memory unit 420 according to whether to use the control bus 440 between the corresponding application processor 410 and the main processor 400. For example, in case that the control bus 440 is used (e.g. the main processor 400 is in communication with the application processor 410 and the main processor 400 controls the application processor 410 by sending a command to the application processor 410), the bypass logic executing unit 430 does not execute the bypass logic. However, in case that the control bus 440 is not used, the bypass logic executing unit 430 sets a route by executing the bypass logic such that data transferred from the main processor 400 can be stored in the supplementary memory unit 420. For example, if the application processor 410 performs the camera function, but executing the camera function is not selected by a user, the main processor 400 sends no command to the application processor 410. This can indicate that the control bus is not used. In this case, the application processor 410 can function as a bridge physically connecting the main processor 400 to the supplementary memory unit 420.

The application processor 410 is basically operated by receiving a command from the main processor 400 through the communication with the main processor 400 by using the control bus 440. Also, in the case of performing an intrinsic operation (an application function), the application processor 410 quickly performs a corresponding operation by using a micro controller unit intrinsically included in the application processor 410. Alternatively, the application processor 410 is converted into a non-driving state (e.g. a sleep mode). If the application processor 410 performs the application function or is converted into a non-driving state (e.g. a sleep mode), that is, the application processor 410 has no communication with the main processor 400, the control bus 440 is not used. The main processor 400 can access the application processor 420 through the bypass logic executing unit 430 by using the control bus that is not used.

Accordingly, the main processor 400 has the efficiency that a total amount of usable memories is increased in spite of being equipped with no additional memory. If the application processor 410 performs the application function or is converted into the non driving state, the bypass logic is executed. Also, the corresponding state information can be transmitted into the main processor 400. Alternatively, if the application processor 410 performs the application function or the application processor 410 is converted into the non driving state and has no communication with the main processor 400 and does not occupy the control bus 440, the bypass logic can be executed in case that the main processor 400 senses this and give a command. Of course, the bypass logic executing unit 430 can be mounted inside of the application processor 410 in a form of a program executing the pertinent bypass logic.

As described above, in accordance with the present invention, the main processor 400 accesses the supplementary memory unit 420 subordinate to the application processor 410 without using a memory bus, to thereby reduce communication lines and have a simple system interface. Further, an interface for connecting the main processor 400 with the supplementary memory unit 420 becomes unnecessary for the main processor 400 by directly connecting the main processor 400 with the supplementary memory unit 420 by the bypass logic executing unit equipped in the application processor 410.

In the case of performing the application function, the application processor 410 accesses the supplementary memory unit 420. Also, there occurs the case that the main processor 400 simultaneously accesses the supplementary memory unit 420 through the control bus 440 and the bypass logic executing unit 430. Here, the supplementary memory unit 420 can be a shared memory having a plurality of access ports. Since the supplementary memory unit 420 has the structure of being coupled to the main processor 400 and the application processor 410, respectively, in common, the supplementary memory unit 420 is required to have two or more access ports.

Referring to FIG. 5, two access ports, identified as a first port 510 and a second port 520, are set so that the first port 510 is connected to the main processor 400 and the second port 520 is connected to the application processor 410. In other words, the first port 510 is connected to the bypass logic executing unit 430, included in the application processor 410, through a first memory bus 450a, and the second port 520 is connected to the application processor 410 through a second memory bus 450b. The main processor 400 and the application processor 410, respectively, can use an independent clock. In FIG. 5, Addr refers to an address signal, Data refers to a data bus and Ctrl refers to a control signal. The control signal can include clock write enable, read enable, chip select and bypass connect.

Also, a storing area of the supplementary memory unit 420 can be partitioned into partitioned sections corresponding to the number of the coupled processors. This is to make it possible for each processor to simultaneously access partitioned sections, respectively, and to write or read data. For example, the storing area is partitioned into a first partitioned section 540 and a second partitioned section 550. The main processor 400 and the application processor 410 can access each partitioned section 540 or 550 at different points of time to write and read data. The temporal consistency of the data is maintained by setting the process to complete one processor before starting the next processor. Also, the supplementary memory unit 420 can include a dedicated area allotted in order to be dedicated for each processor. Each processor can access the dedicated areas allotted to be dedicated through their allotted access ports, in order to read and write data.

The size of each partitioned section (i.e. the first partitioned section 540 and the second partitioned section 550) of the supplementary memory unit 420 can be predetermined as default, can be partitioned into sections having certain sizes by the main processor 400 and the application processor 410, or can be set to be changed at a necessary time (e.g. whenever data desired to be written has the larger size than a writable area) by the main processor 400 and the application processor 410. In other words, address information related to the partitioned section of the storing area of the supplementary memory unit 420 can be set and managed by the main processor 400. The address information set by the main processor 400 is provided to the application processor 410 and is shared with the application processor 410. Of course, the setting and management of the address information can be performed by the application processor 410. As necessary, one of each processor can have the setting authority of the address information and provide the set address information to another processor, to thereby make it possible to share the address information. At this time, information related to the partitioned section of the supplementary memory unit 420 can be recognized by each processor in a booting operation of the portable apparatus.

Also, if the supplementary memory unit 420 is a SDRAM, the supplementary memory unit 420 can be partitioned into sections in units of bank. The typical SDRAM, which includes an RAS address, a CAS address and a bank address, typically consists of 4 banks.

As described above, since the access to the first partitioned section 540 or the second partitioned section 550 is restricted to one processor at the maximum regardless of the access points of time, one of the main processor 400 and the application processor 410 is required to provide the other processor with information related to whether to access the first partitioned section 540 or the second partitioned section 550.

The supplementary memory unit 420 can include a memory controller 530. The memory controller 530 performs an address decoding function and a control function in order that the shared memory can be operated corresponding to a control signal from a processor.

The features of the memory sharing structure of the present invention as compared with the conventional memory sharing structure will be easily understood through the following description.

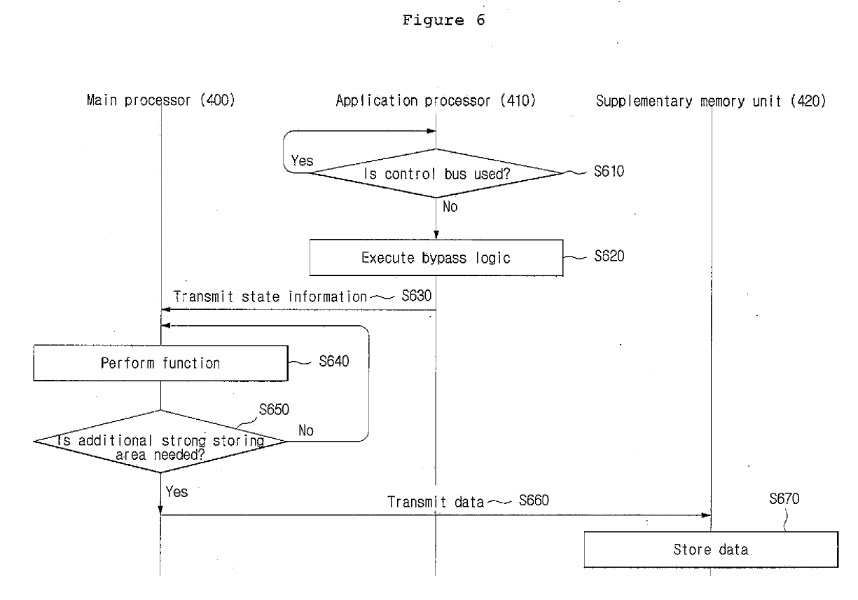

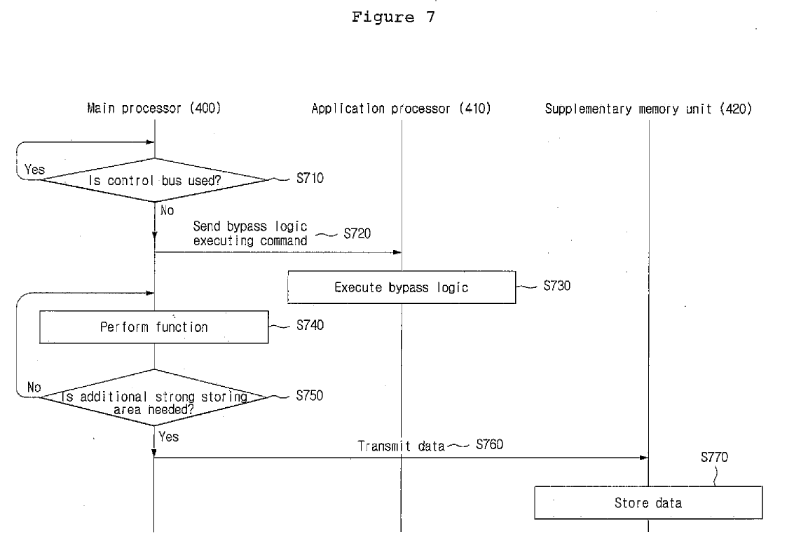

FIG. 6 is a flow chart illustrating a process of storing processing data of a main processor in an supplementary memory unit subordinate to an application processor in accordance with an embodiment of the present invention, and FIG. 7 is a flow chart illustrating a process of storing processing data of a main processor in an supplementary memory unit subordinate to an application processor in accordance with another embodiment of the present invention.

Referring to FIG. 6, in a step represented by S610, the application processor 410 determines whether the control bus 440, which is an interface with the main processor 400, is used. If the main processor 400 communicates with the application processor 410, the control bus 440 is occupied. In this case, since the control bus 440 is used as a communication line between the main processor 400 and the application processor 410, a bypass logic may not be executed.

If the control bus 440 is not used, the application processor 410 executes the bypass logic in a step represented by S620. If the bypass logic is executed, the supplementary memory unit 420 subordinate to the application processor 410 renews a route in a form of being directly connected to the main processor 400.

This is because if the supplementary memory unit 420 is not a shared memory having a plurality of ports and there is no data, processed or to be processed by the application processor 410, it is unnecessary to maintain the relationship between the application processor 410 and the supplementary memory unit 420. In this case, the main processor 400 and the application processor 410 share the supplementary memory unit 420 with each other by accessing the supplementary memory unit 420 at different points of time and writing and reading data.

In case that the supplementary memory unit 420 is a shared memory having a plurality of ports, the main processor 400 and the application processor 410 can simultaneously share the supplementary memory unit 420 with each other by allowing an access port to be connected to the application processor 410 and another access port to be directly connected to the main processor 400 by the execution of the bypass logic.

In a step represented by S630, the application processor 410 can transmit to the main processor 400 state information indicating that the bypass logic is executed.

The main processor 400 performs the function intrinsically allotted in a step represented by S640 and determines whether an additional storing area is needed to store data, processed or to be processed, in a step represented by S650. For example, if the main processor 400 replays a moving picture, the additional storing area may be necessary due to the data, processed or to be processed. Of course, in the case of performing the pertinent function, although the storing area is not lacked, the additional storing area is able to be acquired to improve the processing efficiency.

If the additional storing area is needed, the main processor 400 recognizes that the main processor 400 can be directly connected to the supplementary memory unit 420 from the state information transmitted in the step represented by S630 and transmits data desired to be stored to the supplementary memory unit 420 through a route directly connecting the control bus 440, the bypass logic executing unit 430 and the first memory bus 450a, in a step represented by S660. Also, when attempting to use the supplementary memory unit 420, the main processor 400 can transmit state information indicating a corresponding bus is occupied to the application processor 410.

In a step represented by S670, the supplementary memory unit 420 stores the data transmitted from the main processor 400.

The hitherto description is related to the method of allowing the application processor 410 to determine whether the control bus 440 is used and the main processor 400 to be directly connected to the supplementary memory unit 420. The hitherto description is further related to the case that the application processor 410 transmits the state information to the main processor 400 in that process.

Referring to FIG. 7, since the main processor 400 also occupies the control bus 440, the main processor 400 can determine whether the control bus 440 is used in a step represented by S710. Accordingly, if the control bus 440 is not used, the main processor 400 can allow the application processor 410 to execute the bypass logic by transmitting a bypass logic executing command to the application processor 410 in a step represented by S730.

The description related to the same steps represented by S740 through S770 as those of FIG. 6 will be omitted.

As described above, a digital processing apparatus having a memory sharing structure and a sharing method thereof in accordance with the present invention can reduce communication lines by allowing a main processor and an application processor to share a memory with each other though a control bus.

Also, the present invention can reduce the number of package pins by providing an application processor and a memory as one chip and using no memory pin outside of a corresponding chip package.

The present invention can efficiently apply a much simpler bypass logic than a conventional bus control logic.

The present invention can maximize the capacity of a usable memory that can be used by a main processor.

In addition, the present invention can efficiently a processing time of storing data by omitting a processing operation of an application processor when storing data, desired to be stored, in a memory subordinate to the application processor.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. A digital processing apparatus having a memory sharing structure, the apparatus comprising:
an application processor, performing a predetermined application function, the function including at least one of a camera function and a multimedia playing back function;
a supplementary memory unit, coupled to or inserted into the application processor such that the supplementary memory is subordinate to the application processor; and
a main processor, coupled to the application processor through a control bus and controlling the start or stop of driving the application processor through the control bus,
whereas if communication through the control bus is not performed, a route is connected to directly couple the main processor to the supplementary memory unit through the control bus.

2. The apparatus of claim 1, wherein the supplementary memory unit has two or more ports, and a storing area of the supplementary memory unit is partitioned into n sections, n being a natural number.

3. The apparatus of claim 2, wherein it is possible that the application processor and the main processor simultaneously share the supplementary memory unit at any time.

4. The apparatus of claim 1, wherein the application processor has a bypass logic to connect the route, the bypass logic being executed in case no communication is made between the main processor and the application processor, the application processor transmitting corresponding state information to the main processor after executing the bypass logic.

5. The apparatus of claim 1, wherein the application processor has a bypass logic to connect the route, the bypass logic being executed by a command from the main processor which has detected that no communication is made between the main processor and the application processor.

6. The apparatus of claim 1, wherein the main processor writes or reads data, which is processed or to be processed, in or from the supplementary memory unit supplementary memory through the control bus and the route.

7. A method sharing a memory to allow a main processor to use a supplementary memory unit in a digital processing apparatus, the digital processing apparatus including the main processor, an application processor performing a predetermined application function, and the supplementary memory unit subordinately coupled the application processor, the method comprising:
(a) determining whether communication using a control bus is made between the main processor and the application processor;
(b) if no communication is made, connecting a route to allow the main processor and the supplementary memory unit to be directly coupled to each other by having the application processor execute a bypass logic; and
(c) having the main processor process the data processed or to be processed in the supplementary memory unit, coupled through the control bus and the route.

8. The method of claim 7, wherein the supplementary memory unit has two or more ports, and a storing area of the supplementary memory unit is partitioned into n sections, n being a natural number.

9. The method of claim 8, wherein it is possible that the application processor and the main processor simultaneously share the supplementary memory unit at any time.

10. The method of claim 7, wherein, between the step (b) and the step (c), the application processor transmits corresponding state information to the main processor after connecting the route.

11. The method of claim 7, wherein, in the step (b), the bypass logic is executed by a command from the main processor which has detected that the application processor performs the application function.

12. The method of claim 7, wherein, in the step (c), the main processor writes or reads data, which is processed or to be processed, in or from the supplementary memory unit supplementary memory unit through the control bus and the route.
